(19) United States
(12) Patent Application Publication
(10) Pub. No.: US 2026/0088658 A1
(43) Pub. Date: Mar. 26, 2026

(54) OCULAR SYSTEM WITH ENHANCED INDUCTIVE COUPLING

(71) Applicant: BLINK ENERGY LTD., Haifa (IL)

(72) Inventors: Nadav COHEN, Haifa (IL); Yariv BAR-ON, Yavne (IL)

(21) Appl. No.: 19/112,250

(22) PCT Filed: Nov. 21, 2023
(86) PCT No.: PCT/US2023/080645

§ 371 Date: Mar. 16, 2025

Related U.S. Application Data
(60) Provisional application No. 63/408,507, filed on Sep. 21, 2022.

(51) Int. Cl. H02J 50/12; G02C 7/04; G02C 11/00; H02J 50/00; H02J 50/80; H02J 50/90

(52) U.S. Cl. CPC H02J 50/12; G02C 7/04; G02C 11/10; H02J 50/005; H02J 50/80; H02J 50/90; H02J 2105/46

(57) ABSTRACT

An ocular system includes an ocular device (10), having a coil (16), for deployment in or on the eyeball, and an auxiliary device, including a coil (18), integrated into a patch (12) for deployment on an eyelid or adjacent to the eye. The auxiliary device also includes driver circuitry connected to the auxiliary-device coil, for wirelessly transferring energy and/or exchanging data between the auxiliary device and the ocular device via inductive coupling between the auxiliary-device coil and the ocular-device coil. The auxiliary-device coil (18) has windings of conductive wire about a magnetic core (30) configured so as to define a primary direction of induced magnetic field through the auxiliary-device coil that is tangential to the skin surface.

### FIELD AND BACKGROUND OF THE INVENTION

The present invention relates to energy transfer to, and communications with, ocular devices, such as smart contact lenses and intra-ocular lens (IOL) implants.

Current smart ocular devices (electronic units in the vicinity of the eye) all need a power source and many of them need to transmit data to an external unit (hub, cellphone, cloud). In many cases, there is little space in an ocular device for significant energy storage, which limits energy availability and consequently also functionality of the device. A small power source limits the distance to which communication can be performed, as well as shortening the operational time and limiting applications due to insufficient power.

To address the limited energy storage and provide sufficient energy for proper functioning of an ocular device, additional power is typically supplied to the device (usually wirelessly) periodically by various methods, e.g., inductive coupling, ultrasonic transducers, RF, optical, etc., or by providing an offline charging base. Most of these solutions have a relatively large distance between the transmitter and receiver, resulting in a low efficiency and/or bulky solution. Typical examples of such solutions include an external hand-held unit that is periodically held adjacent to the eye transmitting/receiving data and power from a contact lens device; or a coil, deployed concentrically relative to the eyeball on the orbital surrounding the eye. Solutions based on inductive coupling (near field communication) typically try to deploy coils of the transmitter and receiver concentrically in order to achieve high efficiency and a high coupling factor.

Most “smart” ophthalmic devices are worn/implanted on/in the eyeball (e.g., smart contact lens, prosthetic retina, etc.). Consequently, the devices move with the eye's gazing position. This creates relative movement between any external transmitting coil and the device, thereby hampering implementation of an inductive coupling arrangement with efficient coupling to the ocular device.

### SUMMARY OF THE INVENTION

The present invention is an ocular system with enhanced inductive coupling between an ocular device and an auxiliary device mounted on the eyelid or otherwise adjacent to the eye.

According to the teachings of an embodiment of the present invention there is provided, a system for an eye of a user, the system comprising: (a) an ocular device for deployment in or on an eyeball, the ocular device comprising an energy receiver having an energy-receiving coil; and (b) an energy-transmitting device comprising: (i) an energy-transmitting component comprising at least one coil, the energy-transmitting component integrated into a patch for deploying on or under an external skin surface of an eyelid and/or on or under an external skin surface adjacent to the eye of the user, and (ii) driver circuitry, the driver circuitry being electrically connected to the energy-transmitting component for actuating the energy-transmitting component to transfer energy wirelessly to the energy receiver of the ocular device, wherein the at least one coil has a plurality of windings of conductive wire about a magnetic core, the windings and the magnetic core defining a primary direction of induced magnetic field through the coil that is substantially tangential to the external skin surface.

According to a further feature of an embodiment of the present invention, the at least one coil has a total area of windings lying between the magnetic core and a contact surface of the coil, the total area of windings occupying at least a quarter of a total area of the patch.

According to a further feature of an embodiment of the present invention, the at least one coil has a total area of windings lying between the magnetic core and a contact surface of the coil, the total area of windings occupying at least a third of a total area of the patch.

According to a further feature of an embodiment of the present invention, the at least one coil has a total area of windings lying between the magnetic core and a contact surface of the coil, the total area of windings occupying at least half of a total area of the patch.

According to a further feature of an embodiment of the present invention, the at least one coil is implemented as a single coil.

According to a further feature of an embodiment of the present invention, the at least one coil is implemented as a plurality of coils.

According to a further feature of an embodiment of the present invention, the plurality of coils are deployed such that the primary direction of induced magnetic field through a first coil of the plurality of coils is non-parallel to the primary direction of induced magnetic field through a second coil of the plurality of coils.

According to a further feature of an embodiment of the present invention, the windings having an average winding length, a local thickness of the energy-transmitting coil perpendicular to the external skin surface being no more than one tenth of the winding length.

According to a further feature of an embodiment of the present invention, the windings having an average winding length, a local thickness of the energy-transmitting coil perpendicular to the external skin surface being no more than one fiftieth of the winding length.

According to a further feature of an embodiment of the present invention, the magnetic core is formed as a sheet of material.

According to a further feature of an embodiment of the present invention, the magnetic core is formed with a curvature and the windings are shaped to conform to the curvature so that a length of each winding on one side of the magnetic core is curved to conform to a concave curvature of the magnetic core and a length of each winding on a second side of the magnetic core is curved to conform to a convex curvature of the magnetic core.

According to a further feature of an embodiment of the present invention, at least part of the driver circuitry is located at least partially within the windings of the energy-transmitting coil.

According to a further feature of an embodiment of the present invention, each of the windings has a winding length and an enclosed area, the enclosed area being less than one fifth of an area of a circle have a circumference equal to the winding length.

According to a further feature of an embodiment of the present invention, the enclosed area is less than one tenth of an area of a circle have a circumference equal to the winding length.

According to a further feature of an embodiment of the present invention, the energy-transmitting device further comprises a supplementary energy-transmitting component having a plurality of windings of conductive wire configured so that a primary direction of induced magnetic field through the supplementary energy-transmitting component is substantially perpendicular to the external skin surface.

According to a further feature of an embodiment of the present invention, the driver circuitry is switchable between a first state in which the driver circuitry actuates the energy-transmitting component to transfer energy wirelessly to the energy receiver of the ocular device and a second state in which the driver circuitry actuates the supplementary energy-transmitting component to transfer energy wirelessly to the energy receiver of the ocular device.

There is also provided according to a further feature of an embodiment of the present invention, a system for an eye of a user, the system comprising: (a) an ocular device for deployment in or on an eyeball, the ocular device comprising an ocular-device coil; and (b) an auxiliary device comprising: (i) at least one auxiliary-device coil integrated into a patch for deploying on or under an external skin surface of an eyelid and/or on or under an external skin surface adjacent to the eye of the user, and (ii) driver circuitry, the driver circuitry being electrically connected to the auxiliary-device coil to wirelessly transfer energy and/or exchange data between the auxiliary device and the ocular device via inductive coupling between the auxiliary-device coil and the ocular-device coil, wherein the auxiliary-device coil has a plurality of windings of conductive wire about a magnetic core, the windings and the magnetic core defining a primary direction of induced magnetic field through the auxiliary-device coil that is substantially tangential to the external skin surface.

### BRIEF DESCRIPTION OF THE DRAWINGS

The invention is herein described, by way of example only, with reference to the accompanying drawings, wherein:

FIGS. 1A and 1B are an enlarged front view and an isometric view of an ocular system, constructed and operative according to an embodiment of the present invention, deployed on a user;

FIG. 2A is a plan view of a patch from the ocular system of FIG. 1A;

FIGS. 2B and 2C are cross-sectional views taken along the lines B-B and A-A, respectively, in FIG. 2A;

FIG. 3 is a plot of eyelid angular displacement against time during a typical blinking motion;

FIG. 4 is a grid illustrating schematically relative positions of two coils to facilitate an understanding of their inductive coupling for open and closed eye positions (iv) and (v), in the cases of an excitation coil with: (A) out-of-plane magnetic flux, (B) in-plane magnetic flux; and (C) with a combination of both coils;

FIGS. 5A and 5B are schematic sagittal cross-sectional views taken through the eye of a user when employing an implementation of the ocular system of the present invention with an intraocular device and an external eyelid-mounted auxiliary device, illustrated in a closed state of the eye and an open state of the eye, respectively;

FIGS. 5C and 5D are schematic sagittal cross-sectional views taken through the eye of a user when employing an implementation of the ocular system of the present invention with an intraocular device and an eyelid-implanted auxiliary device, illustrated in a closed state of the eye and an open state of the eye, respectively;

FIG. 6 is a frontal illustration of the muscular physiology of the eyelid with which the auxiliary device interacts;

FIG. 7 is an end view of an auxiliary-device coil from the ocular system of FIG. 1A;

FIG. 8A is an isometric view of an auxiliary-device coil from the ocular system of FIG. 1A illustrating the tangential direction of the magnetic flux through the coil;

FIG. 8B is an isometric view of a spiral coil illustrating the perpendicular direction of the magnetic flux through the coil;

FIGS. 9A and 9B are computer simulations of the magnetic field generated by the coil of FIG. 8A deployed on an eyelid of a user, with and without a magnetic core within the coil, respectively;

FIGS. 10A and 10B illustrate a model employed for computer simulation of inductive coupling between an ocular-device coil and an eyelid-mounted coil according to FIGS. 8A and 8B, respectively;

FIGS. 11A and 11B are maps of inductive coupling values for the models of FIGS. 10A and 10B, respectively, for different gaze directions of the eye;

FIG. 12 is a plot of a normalized inductive coupling factor for the models of FIGS. 10A and 10B over a range of gaze direction elevation angles;

FIG. 13 is a set of schematic drawings illustrating the motion of the eyelids associated with variations in gaze direction;

FIG. 14 is a schematic isometric view of a patch from the ocular system of FIG. 1A which combines the coils of FIGS. 8A and 8B;

FIGS. 15A and 15B are schematic isometric views of alternative implementations of the patch from the ocular system of FIG. 1A which combine multiple coils to provide an equivalent of a larger coil;

FIG. 16 is a schematic isometric view of the system of FIG. 1A implemented using a stand-alone patch for the auxiliary device; and

FIGS. 17A-17D are schematic front views illustrating alternative mounting locations for a patch according to different implementations of the system of FIG. 1A.

### DESCRIPTION OF THE PREFERRED EMBODIMENTS

The present invention is an ocular system with enhanced inductive coupling between an ocular device and an auxiliary device mounted on the eyelid or otherwise adjacent to the eye.

The principles and operation of ocular systems according to the present invention may be better understood with reference to the drawings and the accompanying description.

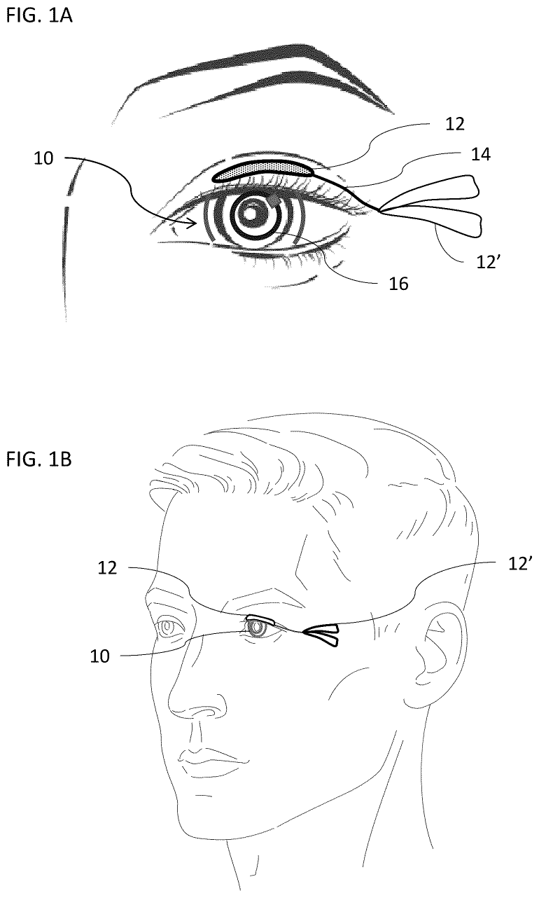

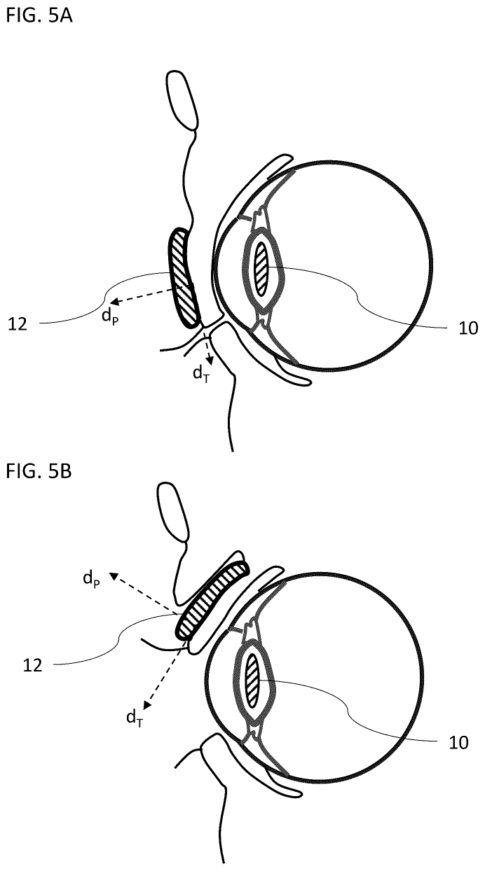

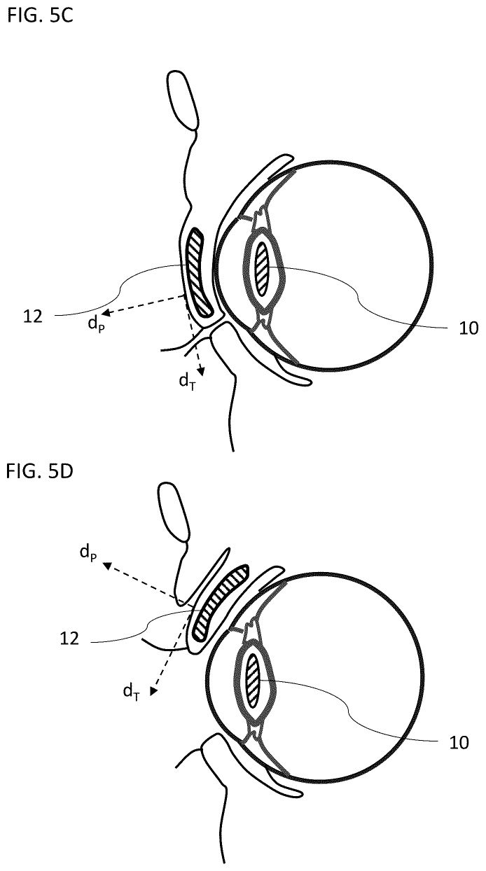

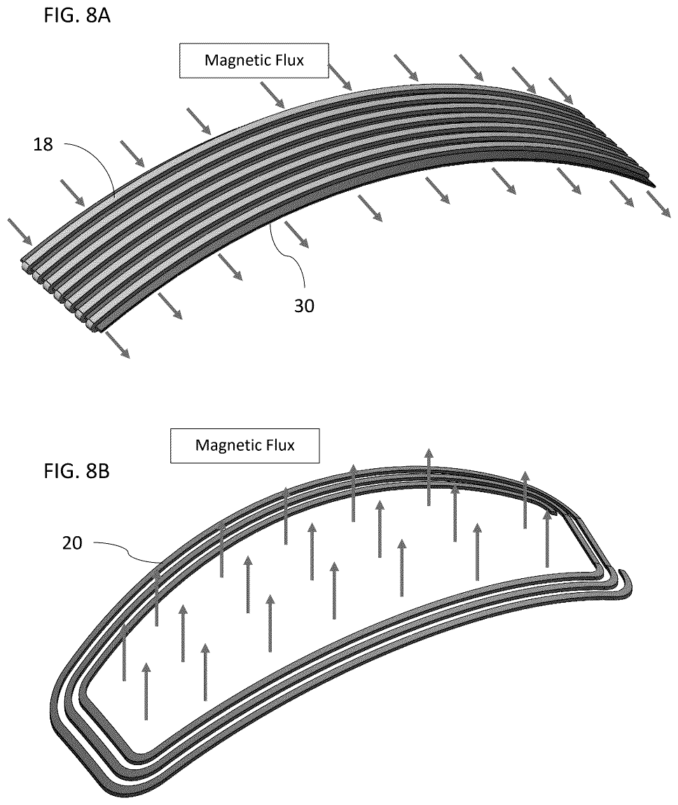

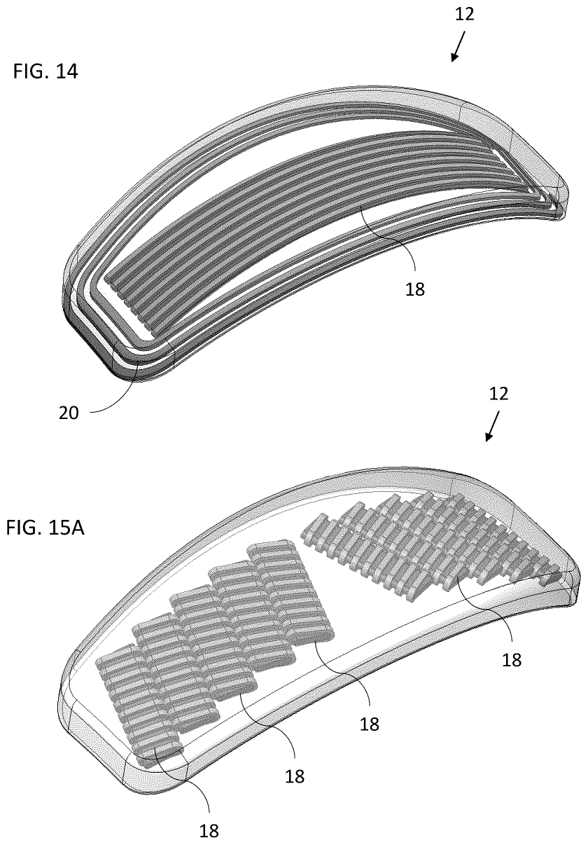

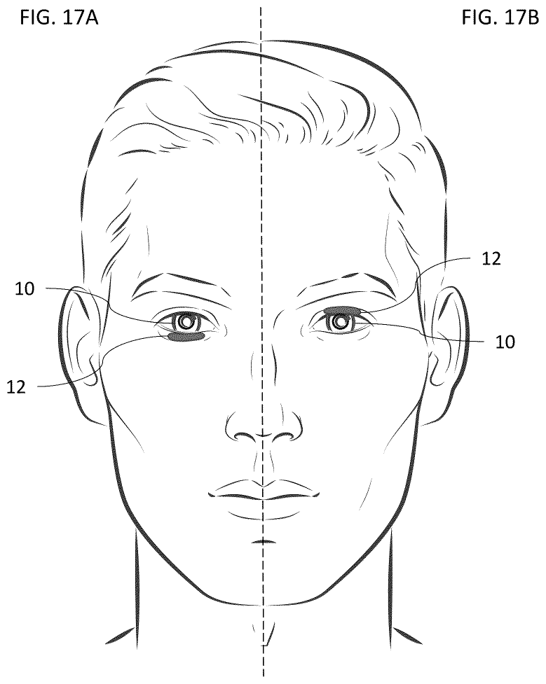

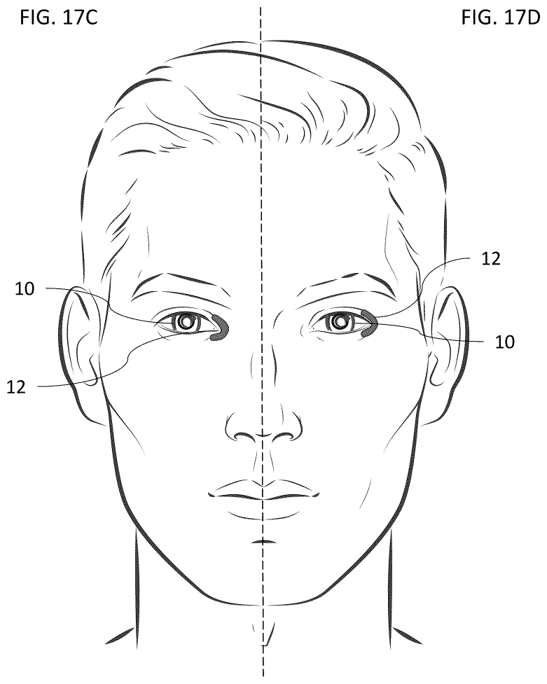

Referring now to the drawings, FIGS. 1A and 1B illustrate an optical system, constructed and operative according to the teachings of an embodiment of the present invention, including an ocular device 10, for deployment in or on an eyeball, the ocular device including an ocular-device coil 16, and an auxiliary device, implemented at least in part in the form of a patch 12. Patch 12 may be self-contained implementation of the auxiliary device. Alternatively, as illustrated here, the auxiliary device may also include components located in a secondary housing 12′, typically tethered to patch 12 via a connecting cable 14. The auxiliary device includes at least one auxiliary-device coil 18 (shown in FIGS. 8A and 14), that is integrated into patch 12 for deploying on or under an external skin surface of an eyelid (FIGS. 1A, 1B and 5A-5D) and/or on or under an external skin surface adjacent to the eye of the user (FIGS. 17A-17D).

The auxiliary device also includes driver circuitry, electrically connected to the auxiliary-device coil, to wirelessly transfer energy and/or exchange data between the auxiliary device and the ocular device via inductive coupling between the auxiliary-device coil and the ocular-device coil.

It is a particular feature of an embodiment of the present invention that the auxiliary-device coil has a plurality of windings of conductive wire about a magnetic core, the windings and the magnetic core defining a primary direction of induced magnetic field through the auxiliary-device coil that is substantially tangential to the external skin surface (direction d_{T} in FIGS. 5A-5D).

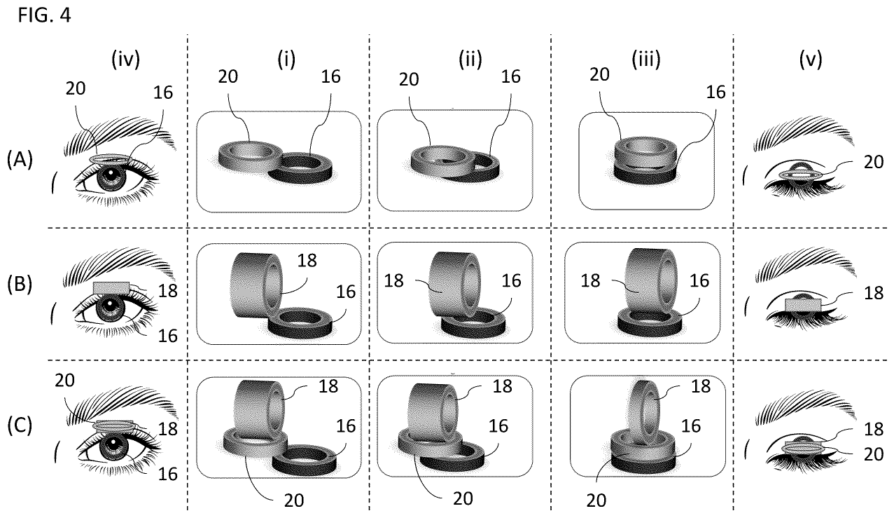

The conceptual significance of this feature may best be understood by reference to FIG. 4.

Prior PCT Patent Application Publication No. WO 2022/107043 (hereafter “the '043 publication”) discloses a flat or “pancake” coil 20, in which the turns are arranged in the form of a flattened spiral) placed on the eyelid (Tx), to energetically couple to an adjacent coil located on a contact lens (Rx). The direction of the magnetic flux within such a coil is essentially perpendicular to the plane of the coil (direction d_{P} in FIGS. 5A-5D). This coil solution may allow some coupling between the receiving coil (Rx) 16 of the ocular device and the transmitting coil (Tx) 20 of the external device because, even though the coils are not concentric, where some of the magnetic fields from the Tx coil pass through the Rx coil. The flatness of the coil allows for a very thin eyelid patch, critical for the ergonomics of the unit. The '043 publication uses an approach which can be better understood with reference to FIG. 4, row (A). When the eye is closed, as in the position (v) (sleeping and blinking), the center axes of coils 16 and 18 align and allows a high coupling factor, resulting in high power coupling (see FIG. 4 A(iii)). But for all other cases where the eye is open (position (iv)), the coils are not concentric (states (i) and (ii)). This results in a solution that does not have a high coupling efficiency, apart from when the eyes are closed, and is very sensitive to the gazing positions. In addition, in cases where the coils partially overlap (state A(ii)), the magnetic field generated by coil 20 falls partially inside and partially outside coil 16, resulting in cancellation of the coupling.

According to this aspect of the present invention, auxiliary-device coil 18 is deployed so that the field within the coil is substantially parallel to the local skin surface (referred to as “tangential” to that surface), corresponding to the geometry illustrated schematically in row (B) of FIG. 4, where coils 16 and 18 have a perpendicular configuration regarding the internal electromagnetic flux direction. The coil 18 is configured such that the magnetic field within the coil is tangential to the eyelid and perpendicular to the Rx coil 16. In this configuration, the field lines pass through the Rx coil without canceling each other. Only when the eyes are closed and the coils are on top of each other (position B(iii)) do the field lines not couple efficiently through the Rx coil, resulting in a reduction of coupling between the coils. For waking hours, this is believed to be an optimal configuration. The blinking cancelation happens only for about 50 ms out of 3-5 s between blinks (see FIG. 3).

FIG. 4 row (C) illustrates schematically a further option, referred to in further detail below, according to which the tangentially-aligned auxiliary-device coil 18 is supplemented by a “pancake” coil 20. It will be appreciated that this combination potentially avoids the low-coupling areas of each type of coil, allowing effective coupling to be achieved in all positions. Optionally, the two coils may be operated continuously in parallel. Alternatively, various inputs indicative of position may be employed as a basis for switching between the two coils, ensuring that the coil that is better placed to achieve inductive coupling at any time is the one used.

While FIG. 4 makes clear the potential advantages of using a coil that is tangentially oriented relative to the local skin surface, it will be clear that such an implementation is not intuitively suited to implementation as an eyelid-mounted patch, or a patch suited to mounting adjacent to the eye.

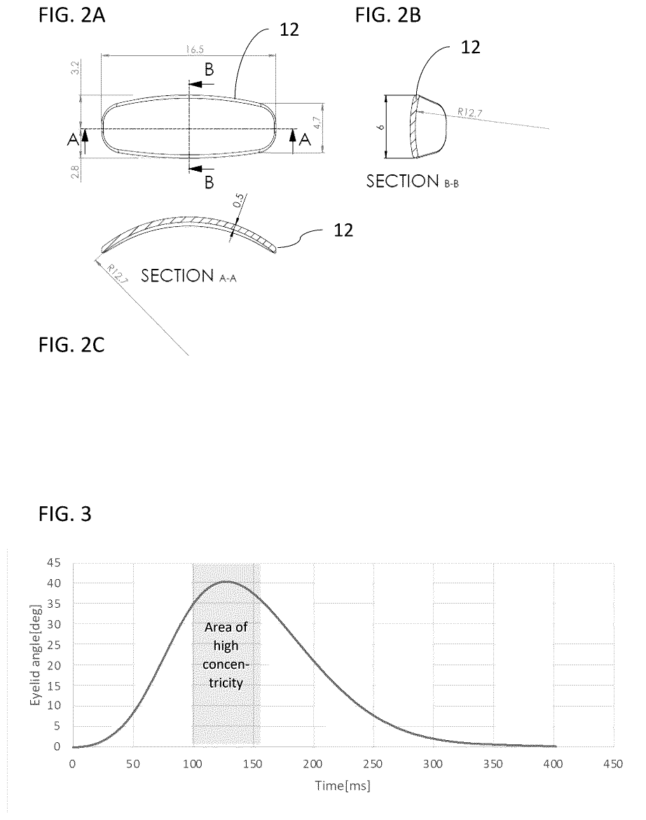

The term “patch” is used herein to refer to any device which has a generally patch-like form factor. In particular, the “patch” is used herein to refer to structures which have a largest dimension referred to as “length”, a second dimension referred to as “width” and a smallest dimension referred to as “thickness”, where the thickness is an order of magnitude less than the length. The patch is preferably, although not necessarily, generally rectangular in plan view (FIG. 2A), optionally modified by rounding of corners and/or a curvature to match to the surface of the body to which it is to be applied (FIGS. 2B and 2C). Preferably, the thickness is also significantly less than the width, and preferably less than 20% of the width. The total local thickness of the patch is preferably no more than 1.5 millimeters, and more preferably no more than about 1 millimeter. One surface of the patch, typically of area corresponding roughly to the length times the width, is a “contact surface” configured for placing in contact with underlying tissue (either skin for an external device or underlying tissue for a device implanted under the skin). In many cases, the patch is formed with a curvature in one or more directions so as to conform to the shape of the tissue against which the contact surface is to be placed. In this case, the “length”, “width” and “thickness” are defined as if the patch were deformed to be flat. As an alternative definition, the “thickness” may be taken as the local thickness of the device measured perpendicular to a tangential plane to the contact surface at any point. The aforementioned dimensions of the patch refer to the active region of the device that houses and contains components of the device, disregarding any peripheral non-functional components, such as a layer of adhesive-coated sheet material which may be provided for attaching a surface-mounted implementation, and disregarding any secondary housing 12′. The “area” of the patch is taken to be the length times the width, for a rectangular patch, or more generally, the area of the contact surface underlying the active region of the patch.

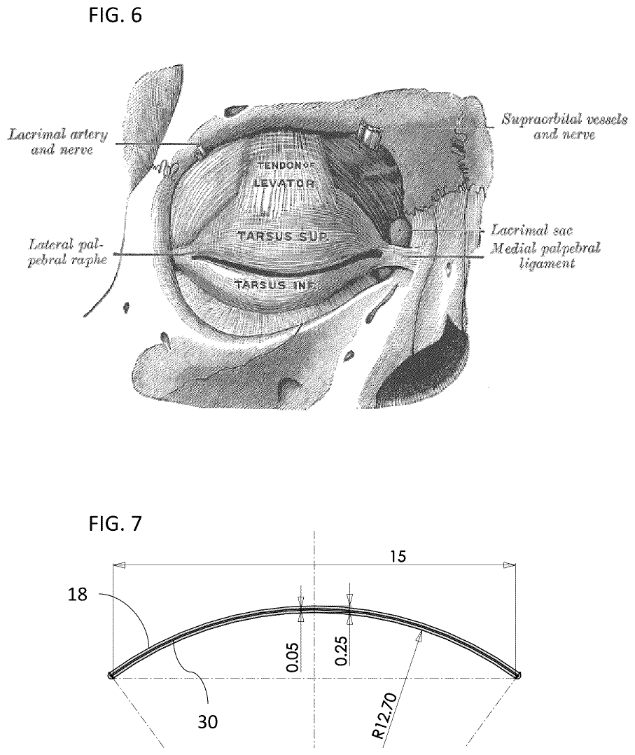

In the case of an eyelid-mounted patch 12, the coil solution should be such that it allows the eyelid patch, when placed on the upper eyelid, to create a fold in the eyelid tissue, thereby forming a pocket within which it sits comfortably. This is illustrated in FIG. 5B, for a surface-mounted patch. In the case of a patch implanted into the eyelid, the folding configuration of the eyelid is similarly modified, as illustrated in FIG. 5D. This modification of the form in which the eyelid folds during retraction is due to the shape and stiffness of the eyelid unit abutting the tissue of the tarsus plates (the physiology of which is illustrated in FIG. 6), which adds localized resistance to folding, thereby causing a larger single fold as shown.

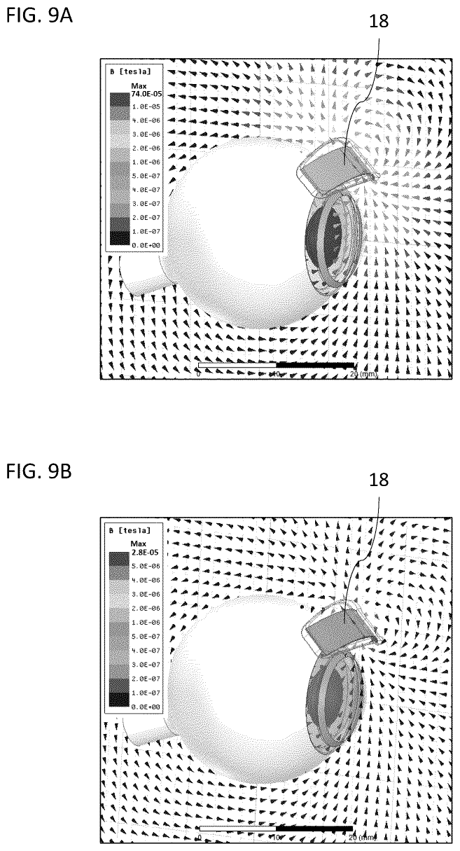

The requirements for the patch to be thin poses a design challenge for a coil with a tangential internal field direction that is to be used for inductive charging and data transfer, since flattening of a coil brings together the two sides of the coil with opposite current, which would cause cancellation of the magnetic flux generated by current through the wires. However, it has been found effective to use a flattened coil with a thin sheet core of magnetic material 30, such as a solid metal solution, powered metal, or ceramic such as a ferrite sheet, preferably with a thickness of less than half a millimeter, and more preferably less than 200 μm, as illustrated in FIG. 8A. Because the transferred energy required for ocular device applications is relatively low for the dimensions of the coil, the thin ferrite sheet does not saturate and allows the coil to operate efficiently although the effective area within the coil turns is reduced to a thin cross section. This presence of the ferrite has particular importance in the case of a flattened coil. Without the ferrite sheet, the top and bottom wire lines of the coil would cancel each other out, resulting in a null inductance. FIG. 9A shows simulation results of the flattened coil placed on the eyelid with the ferrite core, while FIG. 9B shows the same configuration without the ferrite core. Where no ferrite is present, negligible magnetic flux is produced outside the coil, and within the coil, the magnetic flux density is more than 25 times weaker. In this tangential-axis coil design, the entire surface area of the patch can be used for coils which span an entire dimension of the coil area, unlike the flattened spiral of a pancake coil of FIG. 8B, where the coils spiral inwards with progressively reduced effective length.

A simple method of manufacturing such coil is to turn a circular (cylindrical) coil, insert the ferrite sheet into the coil and to press the coil and the ferrite sheet against a curved surface, creating a flattened curved coil with the field direction within the coil pointing tangential to the eyelid, as shown in FIG. 8A. FIG. 7 shows a non-limiting example of the dimensions of such a coil, where the ferrite core is a sheet of thickness 50 μm, the overall radial thickness is about 250 μm, the eyelid-matched curvature has a radius of about 12.7 mm, and the length of the coil is about 15 mm.

The coil thus formed has unusual geometrical properties. Firstly, where the magnetic core is formed with a curvature as shown, conforming to the shape of the skin surface to which it is to be applied or implanted, the windings are preferably also shaped to conform to that curvature. Thus, each winding on one side of the magnetic core is curved to conform to a concave curvature of the magnetic core and each winding on a second side of the magnetic core is curved to conform to a convex curvature of the magnetic core. The coil is also thin compared to the length of each winding. As a result, a local thickness of the auxiliary-device coil perpendicular to the external skin surface is preferably no more than one tenth of an average length of each winding of the coil, or most preferably no more than one fiftieth of the winding length. In the non-limiting exemplary case illustrated in FIG. 7, each winding is roughly 32 mm, while the local thickness of the coil is about 250 μm, giving a winding length to thickness ratio of about 128.

A further unusual geometrical property of the “flat” coils of the auxiliary device is that the enclosed area of the windings is small compared to the length of the windings. Preferably, an enclosed area of each of the windings is less than one fifth, and more preferably less than one tenth, of an area of a circle have a circumference equal to the winding length.

The above geometrical properties are preferably, but not necessarily, maintained for each component coil in the case of a coil arrangement made up of multiple separate smaller coils, as discussed below.

A key parameter in wireless power transfer is the coupling factor of the coupled coils, k. For a coupled coil pair, the coupling factor is given by the following equation:

$$k = \frac{\vert {M}_{1 , 2} \vert}{\sqrt{{M}_{1 , 1} {M}_{2 , 2}}}$$

Where M is the Inductance Matrix. This coefficient indicates how much flux in one coil is linked (flows through) with the other coil. If all the flux in one coil reaches the other coil, k=1, if no flux reaches the other coil, k=0.

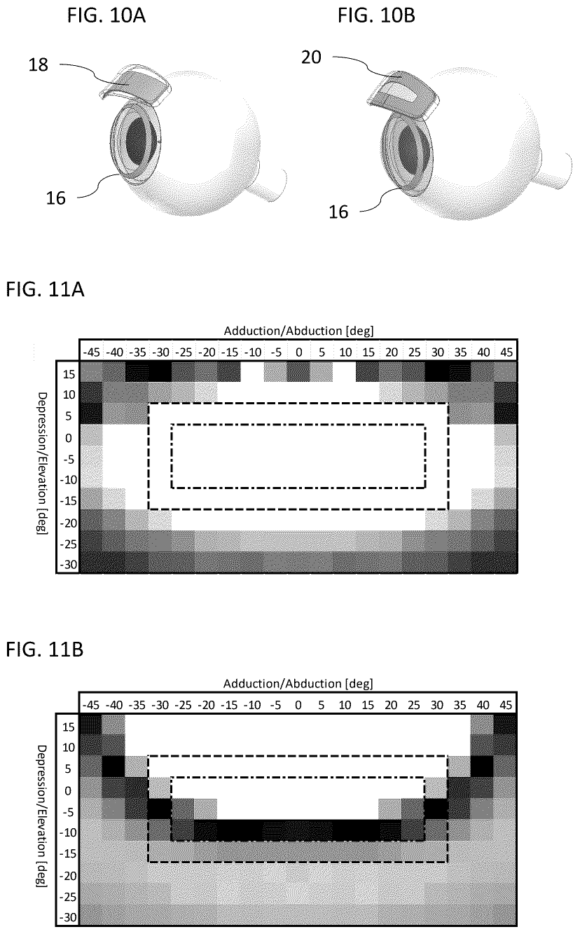

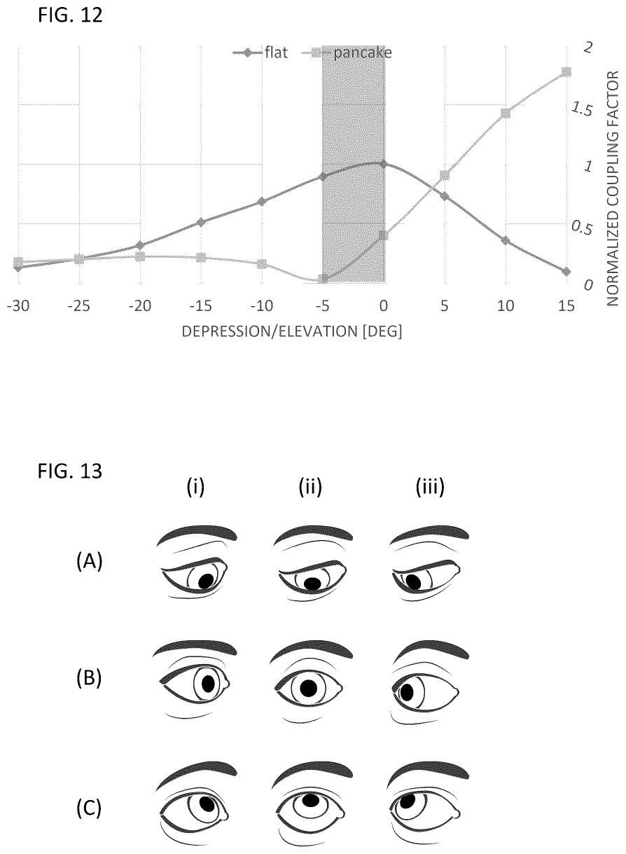

FIGS. 10A and 10B show geometrical models employed to calculate simulated results of the coupling between auxiliary-device coil 18 and ocular-device coil 16, or between a pancake coil 20 and ocular-device coil 16, respectively, for an eyelid-mounted auxiliary device over a range of gazing directions. FIGS. 11A and 11B show, respectively, the corresponding simulation results for a transmitter coil within a patch on the eyelid transmitting power to a coil located in a contact lens. In the open state of the eye with a horizontal gaze direction, the eyelid patch is assumed to be 30-degrees above the horizontal gaze position. For equivalency, the simulations for both coil configurations are calculated based on the same magnetomotive force, N×I (45 mA), where N is the number of turns and I is the winding current, the same winding cross-section, A (0.45 mm²), defined by the current direction (ensuring similar wire dimensions) and a similar overall copper volume (˜15 mm³). The coupling factor of the coil is indicated using gray-scale shading as a function of the gaze direction at different angles of Depression/Elevation and Adduction/Abduction (also referred to as medial/lateral rotation). The white area shows where the coupling factor is sufficient while the gray area shows where it is insufficient. FIG. 11A illustrates that the flattened coil 18 of the present invention provides effective coupling for most of the gazing positions while the pancake coil 20 is efficient only towards the top of the range of gaze angles. This simulation was calculated using an assumption that the eyelid-mounted coil remains stationary at its initial position of 30 degrees above horizontal. In fact, when the eye moves, the eyelid moves somewhat with it, particularly in the up/down direction, keeping the angular distance between the Tx and Rx coils smaller than calculated. This will tend to further enlarge the region of effective coupling of FIG. 11A. FIG. 13 shows schematic illustrations of how the eyelid moves with eye movement. The most relevant angles are when the eyelid covers the topmost part of the iris, equivalent, in this case to −5 to 0 deg elevation gaze. To further highlight the advantage of the flat coil over the pancake coil design, FIG. 12 shows the coupling factor for most of the elevation/depression gazing position in a forward gaze. The coupling factor is normalized by the maximum value of the flat coil. In the figure, the most common gaze angles are highlighted by a green transparent rectangle. In this area, it is clearly seen that the pancake coil coupling factor is low while the flat coil reaches a peak.

For transmitting energy to the ocular device, appropriate driver circuitry and an associated power storage component (e.g., battery) is electrically connected to the energy-transmitting component (one or more auxiliary-device coils 18) for actuating energy-transmitting component to transfer energy wirelessly to the energy receiver (ocular-device coil 16) of the ocular device. This driver circuitry can be incorporated into the patch, either alongside the coil (or coils) or, in some cases, at least partially encompassed by windings of the coil(s). FIG. 16 shows schematically an implementation in which all components are integrated as part of patch 12. In the example shown here, coil 16 underlies the electronic components. Alternatively, in certain implementations (not shown), at least some of the electronic components, such as, for example, driver circuitry for driving the coil, may be located at least partially within the windings of coil 16.

As an alternative to this self-contained unitary implementation, part or all of the driver circuitry, power storage component and/or other electronic components may be located in a secondary housing 12′ that is separate from patch 12, at an alternative body-mounted location, interconnected with the patch by suitable electrical connections 14, for example, with a form factor similar to that illustrated in FIGS. 1A and 1B. In the latter case, patch 12 may optionally contain only the auxiliary-device coil(s), without additional components.

As mentioned above with reference to FIG. 4 row (C), to enhance the coupling factor for all gazing positions and during sleeping or blinking, the two coil designs can be joined for a single coupling solution where either both coils are working all the time, or they are switched according to the relative location of the coils relative to the coil of ocular device 10. The switching can be done according to the measured reflected impedance of each coil resulting for the Rx and Tx coil coupling. Alternatively, the winking and gazing position may be sensed with an accelerometer sensing the acceleration of the eyelid or a strain gauge measuring the deformation due to the eye bulge deforming the eyelid as relative movement is done. FIG. 14 shows the eyelid patch with two coils assembled together. The combination of two such coils may provide a combination of the effective coupling coverage for a wide range of Depression/Elevation gaze angles, effectively combining the white coupling-regions of FIGS. 11A and 11B.

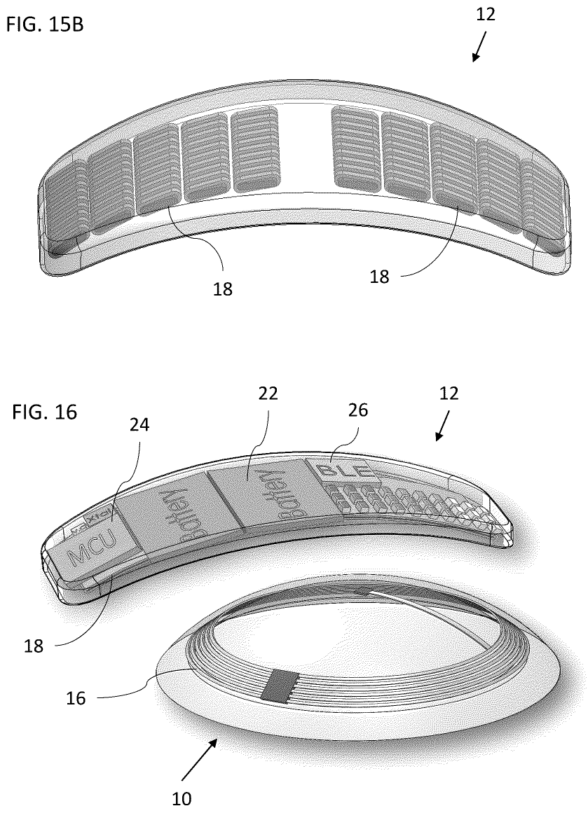

The design of the flat coil 18 is not limited to a single coil with a single magnetic core. The flat coil can be implemented as a set of multiple small coils, each with a magnetic core, with an overall effect equivalent to the larger coil. In such a case, the magnetic field is still tangential to the eyelid skin, but the individual coils may optionally be directed in different tangential directions to better shape the overall magnetic flux density distribution outside the equivalent coil perimeter. FIGS. 15A and 15B illustrate schematically two such implementations. In some embodiments, some of the sub-coils can be removed to allow placement of electronics without adding to the overall thickness of the patch. The sum effect of the small coils can be equated to an “equivalent coil” described by an imaginary surface engulfing all the sub-coils while the inner magnetic cores can be equated to an equivalent core defined by an engulfing surface of all the cores. Using this equivalence, as long as the field direction is as described above and equivalent dimensions of the design are similar, considerable design flexibility can be provided, with many possible implementations of a thin patch with a magnetic field direction tangential to the skin surface. In the example of FIG. 15A, an equivalent coil is composed of 8 sub-coils with a tangential inner field. The different sub-coils are deployed in two groups at an angle relative to each other while the space in the middle can be used for other components of the patch as a system. Thus, the primary direction of induced magnetic field through a first coil of the plurality of coils is non-parallel to the primary direction of induced magnetic field through a second coil of the plurality of coils. FIG. 15B shows an equivalent coil composed of 10 sub-coils with a tangential inner field. In this example, the different sub-coils are all parallel, while the space in the middle can again be used for other components of the patch as a system.

To optimize the flux through the auxiliary-device coil, the coil or coils preferably cover a significant proportion of the total area of patch 12. The “area” of the coil(s) for this purpose can be regarded as the total area of windings lying between the magnetic core and a contact surface of the patch (i.e., the surface which contacts the skin surface or, in the case of an implant, the base surface of the implant which is placed against underlying tissue). The total area of windings, which may be from a single large coil or the sum total of a number of smaller coils, preferably occupies at least a quarter, more preferably at least a third, and in certain preferred cases at least half, of a total area of the patch.

The present invention may be implemented in a wide range of applications where energy transfer to, and/or communication with, an ocular device is required. Examples of types of implants to which the present invention may be applied include, but are not limited to, one or more of the following devices or functions: IOP, retinal prosthesis, shunts, migs, glucose metering, drug delivery device, accommodative/refractive lens, dry-eye treatment, and tissue restoration.

Examples of smart device to which the present invention may be applied include, but are not limited to, one or more of the following devices or functions: IOP contact lens (CL), drug delivery CL, accumulative CL, augmented reality (AR) CL, extended reality (XR) CL, drug eye management CL, blinking stimulation CL, Drug delivery patch, Drug eye management patch, communication patch, blinking stimulation patch (for facial paralysis).

In each of the above cases, the components of the ocular device are generally standard, and will not be described herein, other than those required for the energy transfer and/or communication according to the teachings of the present invention, which are described below. For the purpose of this document, unless otherwise stated or self-evident from the context, the term “ocular” in relation to positioning of a device refers to any location that is internal to the eyelid when closed, whether applied to an outer surface of the eye (“supra-ocular”, e.g., a contact lens) or whether implanted within tissue of the eye (“intra-ocular”). Conversely, the term “extra-ocular” or simply “external” refers to any location that is outwards from at least part of a thickness of the eyelid, or otherwise positioned externally to the eye.

In all other respects, the structure, deployment and operation of the devices of the present invention may advantageously be implemented in a manner similar to that described in the aforementioned PCT Patent Application Publication No. WO 2022/107043. Certain aspects of that implementation are addressed further below. Further details of these and other features may be found in the '043 publication.

### Energy Coupling

In order to allow energy supply to ocular device 10, the ocular device is implemented with an energy-receiver coil 16, and auxiliary device 12 includes an electrically-actuated energy-transmitting coil 18. Auxiliary device 12 also includes driver circuitry, electrically connected to the energy-transmitting coil, for actuating the energy-transmitting component to transfer energy wirelessly to the energy receiver of the ocular device. The driver circuitry may either be integrated with the eyelid-mounted component, or can be partially or entirely located in supplementary housing 12′, where used.

The close proximity of the energy-transmitting component to the energy receiver allows particularly effective transfer of energy by near field inductive coupling. Most preferably, in order to avoid losses due to power radiating to the far field, frequencies in the RF range are preferred, corresponding to wavelengths significantly greater than the coil dimensions.

It has been found particularly effective to perform energy transfer from the auxiliary device to the ocular device by near-field resonant coupling. To this end, the energy receiver of ocular device 10 preferably includes a receiver resonant circuit including a near-field receiver antenna, and the energy-transmitting component of auxiliary device 12 preferably includes a near-field transmitter antenna which is part of a transmitter resonant circuit. The two resonant circuits are designed (tuned) at the same resonant frequency, and the driver circuitry drives oscillation of the transmitter resonant circuit at a tuned resonant frequency of the coupled resonant system so as to induce resonance in both the transmitter resonant circuit and the receiver resonant circuit. Power can then be recovered efficiently from the transmitter resonant circuit by the ocular device.

The use of resonant coupling in the reactive near-field is highly advantageous for maximizing energy transfer efficiency. By employing near-field antennae (typically of small dimensions relative to the wavelength), transmitted energy losses to the environment are kept to a minimum. The use of coupled resonant circuits in the transmitter and receiver ensures that energy losses of the driving circuitry are kept to a minimum, allowing relatively high-power transfer efficiency even when coupling between the transmitter and receiver resonant circuits is relatively low. The term “inductive near-field resonant coupling” is used herein synonymously with the term “magnetic resonance coupling.”

Other components of external auxiliary device 12, illustrated by way of one non-limiting example in FIG. 16, typically include a battery 22, an application-specific integrated circuit (ASIC) or other microcontroller unit (MCU) 24, and other components such as low-energy Bluetooth (BLE) communication components 26, sensors and/or other peripheral electronic components, all preferably encapsulated in a protective encapsulation.

Particularly, but not exclusively, for external devices mounted on the upper eyelid, relative positioning of the transmitter antenna and the receiver antenna, and the resulting coupling therebetween, vary considerably during operation, due to eye motion and blinking. The system preferably includes a resonance tracking (auto-tuning) circuit, which can detect and correct for resonance frequency shift arising from varying impedance due to relative movement between the two coils arising from the eye movement, and from additional parameter shifts such as temperature etc. This decreases the sensitivity for alignment and distance variations, facilitating maintenance of high efficiency and a constant supply of energy despite variations in position and other varying parameters. Resonance tracking circuits are known per se in the art, and can readily be implemented by a person ordinarily skilled in the art.

Optionally, where data transfer between the ocular device and the auxiliary device is available, the ocular device may transmit back to the external device information indicating the actual power received, thereby indicating the power transfer efficiency (PTE). This allows closed-loop operation in which the required power is transmitted on the basis of the power actually received.

### High-Power Applications

One aspect of the significance of providing power from an external device can be appreciated by referring to examples of high-power applications. High power applications, such as an augmented reality contact lens or various active prosthetics, require a lot of energy relative to what can be stored by an onboard battery within a contact lens. In some cases, even of all the available area within a contact lens is used for power storage, the power would only be sufficient for a few hours' operation or less.

Furthermore, inclusion of significant battery storage capacity is typically incompatible with use of a soft contact lens because the flexibility is lost, and the thickness of the contact lens quickly increases to make it uncomfortable. Inclusion of batteries into a soft contact lens is also typically incompatible with normal manufacturing techniques for soft lenses.

By moving the power source offboard to the external device, it becomes possible to implement even a high-power application using a thin and comfortable solution within a soft contact lens with hundreds of times more power than what can be packed within a contact lens.

By way of a numerical example, the maximum power that can be currently packed on to a contact lens is of an order of P=0.5 mWh. This is based on an assumed energy density of 100 Wh/liter. Thus, and application which requires roughly 0.5 mW of power can only operate for up to about 1 hour based on an onboard power supply.

In contrast, if using an external device that is a self-contained eyelid-mounted unit, the eyelid-mounted unit can carry a battery that supplies P=50 mWh. Even if we assume an energy transfer efficiency of 20%, this would still make available P=10 mWh, which would be sufficient for 20 hours of operation at 0.5 mW. For embodiments with an additional unit 12b, the available power can be increased by tens of times beyond this figure.

Depending on the implementation, the power supplied from auxiliary device 12 can be provided continuously to ocular device 10, where it is rectified and managed continuously to power the device. Alternatively, ocular device 10 may include a power storage element, such as a power storage capacitor, which allows continuous operation of the ocular device 10 if power from auxiliary device 12 is interrupted.

### Data Transmission

As an alternative or addition to the power transfer discussed thus far, according to a further aspect of the present invention, auxiliary device 12 is configured to transfer data to and/or from the ocular device. Here too, the presence of a body-mounted external device in proximity to the ocular device greatly reduces the power requirements for data transfer compared to direct communication from an ocular device to a more remote device. The auxiliary device 12 preferably also includes a wireless communications interface for communicating with a communications network or with a mobile electronic device, thereby allowing it to exchange data with an external device.

In basic terms, this aspect of the present invention employs a first communication subsystem that is part of the ocular device 10, and the auxiliary device 12 has a second communication subsystem, preferably associated with antenna 16, for transferring data wirelessly to and/or from the first communication subsystem.

In a particularly preferred subset of implementations, where auxiliary device 12 also provides power to ocular device 10, this data communication is implemented via modulation of the power transmission to convey encoded data. For data transfer from the external device to the ocular device, driver circuitry of the external device is configured to convey data via modulation of an amplitude of power transfer to the ocular device, either as switching between two or more amplitude levels or by introducing brief interruptions in the transmitted power. The ocular device is implemented with corresponding electronic circuitry associated with the receiver resonant circuit and configured to derive the data from the modulation.

For data transfer from the ocular device 10 to the auxiliary device 12, the ocular device includes electronic circuitry associated with the receiver resonant circuit and configured to convey data via load modulation of the receiver resonant circuit. This load modulation causes a corresponding variation in the current of the transmitter resonant circuit, which is detected and decoded by the circuitry of the auxiliary device 12.

The ability to transfer information from the ocular device to the auxiliary device also facilitates optimized operation of power transfer to the ocular device. The ocular device may advantageously report back to the external device the actual power received by the ocular device, allowing the external device to adjust the transmitted power to reach a specific required power transfer target for operation of the ocular device.

Optionally, a wireless communications subsystem may be incorporated into the auxiliary device to allow connection to an external device, such as for reporting the status of the battery and/or receiving scheduling data for when, and for how long, the ocular unit should be activated. Typical examples of such communication components are transceivers configured to transmit and receive data according to standard NFC or BLE protocols. The communication components may employ dedicated antennae for this channel of communication. Alternatively, in some cases, the transmission and reception may be performed by superposition of the signals via the same antennae employed for the resonant coupling.

In some cases, the communication component of the external device employed for data transfer with the ocular device may also be used for communication with a network or mobile device. In other cases, due to differences in the required power and antenna design, it may be preferable to provide a separate communication component for communication with a network or mobile device, such as the BLE component illustrated here.

The data communication is preferably bidirectional. This can be implemented via modulation of the power transmission. For data transfer from the auxiliary device to the ocular device, the external device MCU preferably switches the RF driver to convey data via modulation of an amplitude of power transfer to the ocular device. In one particularly simple implementation, data can be conveyed by generating brief off/on pulses in the RF driver output, where different pulse durations or cycle times indicate a “0” or a “1”. Clearly, this example is only one of an unlimited number of schemes for transferring data by amplitude modulation over the power signal. The modulation is then sensed by the ocular device, typically as variations in output voltage from the rectifier which can be sensed by the ocular device MCU, which decodes the transmitted date from the modulation.

For transmission of data from the ocular device to the external auxiliary device, the MCU of the ocular device preferably encodes data by performing load modulation of the receiver resonant circuit, which causes a corresponding variation in the current of the transmitter resonant circuit. These variations are detected by envelope detection circuitry. The external device MCU then decodes the data from the sensed variations in the envelope of the transmitter resonant circuit power.

It will be appreciated that the above descriptions are intended only to serve as examples, and that many other embodiments are possible within the scope of the present invention as defined in the appended claims.

What is claimed is:

1. A system for an eye of a user, the system comprising:
(a) an ocular device for deployment in or on an eyeball, said ocular device comprising an energy receiver having an energy-receiving coil; and
(b) an energy-transmitting device comprising:
(i) an energy-transmitting component comprising at least one coil, said energy-transmitting component integrated into a patch for deploying on or under an external skin surface of an eyelid and/or on or under an external skin surface adjacent to the eye of the user, and
(ii) driver circuitry, said driver circuitry being electrically connected to said energy-transmitting component for actuating said energy-transmitting component to transfer energy wirelessly to said energy receiver of said ocular device,
wherein said at least one coil has a plurality of windings of conductive wire about a magnetic core, the windings and the magnetic core defining a primary direction of induced magnetic field through said coil that is substantially tangential to the external skin surface.

2. The system of claim 1, wherein said at least one coil has a total area of windings lying between said magnetic core and a contact surface of said coil, said total area of windings occupying at least a quarter of a total area of said patch.

3. The system of claim 1, wherein said at least one coil has a total area of windings lying between said magnetic core and a contact surface of said coil, said total area of windings occupying at least a third of a total area of said patch.

4. The system of claim 1, wherein said at least one coil has a total area of windings lying between said magnetic core and a contact surface of said coil, said total area of windings occupying at least half of a total area of said patch.

5. The system of claim 1, wherein said at least one coil is implemented as a single coil.

6. The system of claim 1, wherein said at least one coil is implemented as a plurality of coils.

7. The system of claim 6, wherein said plurality of coils are deployed such that the primary direction of induced magnetic field through a first coil of said plurality of coils is non-parallel to said primary direction of induced magnetic field through a second coil of said plurality of coils.

8. The system of claim 1, wherein said windings having an average winding length, a local thickness of said energy-transmitting coil perpendicular to the external skin surface being no more than one tenth of said winding length.

9. The system of claim 1, wherein said windings having an average winding length, a local thickness of said energy-transmitting coil perpendicular to the external skin surface being no more than one fiftieth of said winding length.

10. The system of claim 1, wherein said magnetic core is formed as a sheet of material.

11. The system of claim 1, wherein said magnetic core is formed with a curvature and said windings are shaped to conform to said curvature so that a length of each winding on one side of said magnetic core is curved to conform to a concave curvature of said magnetic core and a length of each winding on a second side of said magnetic core is curved to conform to a convex curvature of said magnetic core.

12. The system of claim 1, wherein at least part of said driver circuitry is located at least partially within said windings of said energy-transmitting coil.

13. The system of claim 1, wherein each of said windings has a winding length and an enclosed area, said enclosed area being less than one fifth of an area of a circle have a circumference equal to said winding length.

14. The system of claim 13, wherein said enclosed area is less than one tenth of an area of a circle have a circumference equal to said winding length.

15. The system of claim 1, wherein said energy-transmitting device further comprises a supplementary energy-transmitting component having a plurality of windings of conductive wire configured so that a primary direction of induced magnetic field through said supplementary energy-transmitting component is substantially perpendicular to the external skin surface.

16. The system of claim 15, wherein said driver circuitry is switchable between a first state in which said driver circuitry actuates said energy-transmitting component to transfer energy wirelessly to said energy receiver of said ocular device and a second state in which said driver circuitry actuates said supplementary energy-transmitting component to transfer energy wirelessly to said energy receiver of said ocular device.

17. A system for an eye of a user, the system comprising:
(a) an ocular device for deployment in or on an eyeball, said ocular device comprising an ocular-device coil; and
(b) an auxiliary device comprising:
(i) at least one auxiliary-device coil integrated into a patch for deploying on or under an external skin surface of an eyelid and/or on or under an external skin surface adjacent to the eye of the user, and
(ii) driver circuitry, said driver circuitry being electrically connected to said auxiliary-device coil to wirelessly transfer energy and/or exchange data between said auxiliary device and said ocular device via inductive coupling between said auxiliary-device coil and said ocular-device coil,
wherein said auxiliary-device coil has a plurality of windings of conductive wire about a magnetic core, the windings and the magnetic core defining a primary direction of induced magnetic field through said auxiliary-device coil that is substantially tangential to the external skin surface.
